(19) United States
(12) Patent Application Publication
(10) Pub. No.: US 2012/0170882 A1
(43) Pub. Date: Jul. 5, 2012

(54) FAN BEARING RETAINING STRUCTURE

(75) Inventor: Wen-Hao Liu, Sinjhuang City (TW)

(73) Assignee: ASIA VITAL COMPONENTS CO., LTD., Sinjhuang City (TW)

(21) Appl. No.: 12/983,324

(22) Filed: Jan. 2, 2011

(51) Int. Cl. F16C 35/00

(52) U.S. Cl. 384/428

(57) ABSTRACT

A fan bearing retaining structure includes a fan base, a bearing and at least one resilient member. The fan base has a bearing bushing perpendicularly extending from one face of the fan base. The bearing bushing is formed with a bushing bore in which the bearing is disposed. An annular groove is formed on an inner circumference of the bearing bushing. The resilient member is fitted around the outer circumference of the bearing and correspondingly received in the annular groove. The resilient member serves to eliminate the gap between the bearing and the bearing bushing so as to avoid vibration of the bearing. In this case, the fan can operate more stably and the lifetime of the fan can be prolonged. Moreover, the noise can be minified.

### FIELD OF THE INVENTION

The present invention relates to a fan bearing retaining structure, and more particularly to a fan bearing retaining structure, which can eliminate the gap between the bearing bushing and the bearing so as to reduce friction and avoid vibration of the bearing.

### BACKGROUND OF THE INVENTION

In an electronic product, the electronic components will produce high heat in operation. In case the electronic components are continuously in a high temperature state, the electronic components will have deteriorated execution efficiency or even burn out. In order to avoid deterioration of the execution efficiency or burnout of the electronic components, the electronic product is generally equipped with at least one heat dissipation unit (such as a radiating fin assembly or a heat sink) and a cooperative cooling fan to dissipate the heat generated by the electronic components so as to prolong the lifetime thereof.

When assembling the bearing of a conventional fan, in order to facilitate the assembling process, the outer ring of the bearing is assembled with the bearing bushing in a loose-fit manner and the inner ring of the bearing is also assembled with the shaft of the fan in the same manner. The bearing can be quickly assembled in such manner. However, when the fan operates, the inner ring of the bearing and the shaft will vibrate relative to each other to cause oxidization of the shaft. Under such circumstance, the shaft will clog in the bearing to make noise.

Also, the bearing is not fully fixedly assembled with the bearing bushing and there is a gap existing between the bearing bushing and the bearing. Therefore, when the impeller of the fan rotates, the bearing will vibrate to make noise.

In the case that the bearing is assembled with the bearing bushing in a press-fit manner to eliminate the gap between the bearing and the bearing bushing, the bearing bushing and the bearing both need to be manufactured in high precision. This leads to greatly increased manufacturing cost. In addition, when assembled, the ball members inside the bearing are likely to damage to cause vibration of the fan and make noise in operation. Therefore, the conventional device has the following shortcomings:

1. The fan tends to vibrate in operation.

2. The gap between the bearing and the bearing bushing is too large.

3. The fan will make noise in operation.

4. The lifetime of the fan is shortened.

### SUMMARY OF THE INVENTION

A primary object of the present invention is to provide a fan bearing retaining structure, which can enhance stability of the fan in operation.

A further object of the present invention is to provide the above fan bearing retaining structure, which can prolong the lifetime of the fan.

To achieve the above and other objects, the fan bearing retaining structure of the present invention includes a fan base, a bearing and a resilient member. The fan base has a bearing bushing perpendicularly extending from one face of the fan base. The bearing bushing is formed with a bushing bore in which the bearing is disposed. The bearing has an outer circumference. An annular groove is formed on an inner circumference of the bearing bushing. The resilient member is fitted around the outer circumference of the bearing and received in the annular groove. The resilient member serves to eliminate the gap between the bearing and the bearing bushing, whereby the bearing can be securely assembled with the bearing bushing without vibrating. In this case, the fan can operate more stably and the lifetime of the fan can be prolonged.

According to the above, the present invention has the following advantages:

1. The present invention is able to avoid vibration of the bearing.

2. The present invention is able to prolong the lifetime of the fan.

3. The present invention is able to enhance stability of the fan in operation.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a sectional exploded view of a first embodiment of the present invention;

FIG. 2 is a sectional assembled view of the first embodiment of the present invention;

FIG. 3 is a sectional exploded view of a second embodiment of the present invention;

FIG. 4 is a sectional assembled view of the second embodiment of the present invention; and

FIG. 5 is a sectional assembled view of a third embodiment of the present invention.

### DETAILED DESCRIPTION OF THE PREFERRED EMBODIMENTS

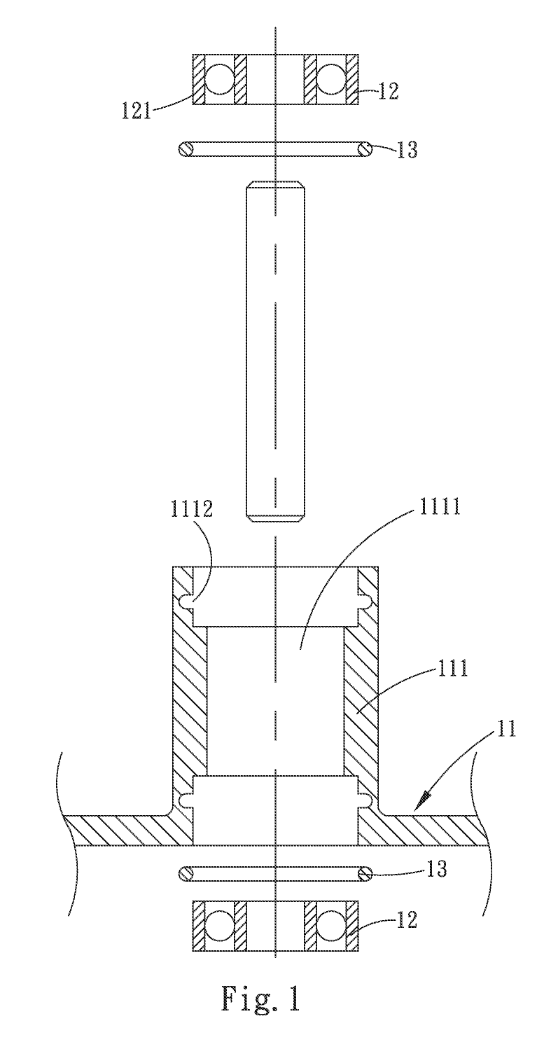

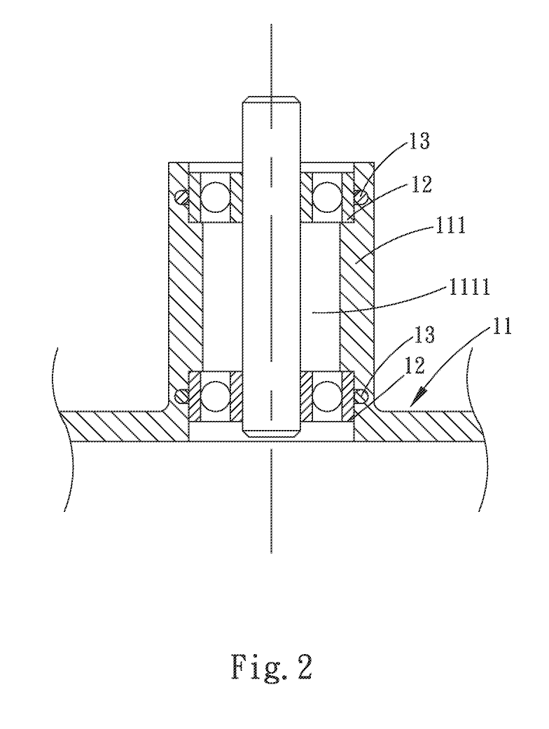

Please refer to FIGS. 1 and 2. FIG. 1 is a sectional exploded view of a first embodiment of the present invention. FIG. 2 is a sectional assembled view of the first embodiment of the present invention. According to the first embodiment, the fan bearing retaining structure of the present invention includes a fan base 11, a bearing 12 and a resilient member 13.

The fan base 11 has a bearing bushing 111 perpendicularly extending from one face of the fan base 11. The bearing bushing 111 is formed with a bushing bore 1111 axially extending through the bearing bushing 111. An annular groove 1112 is formed on an inner circumference of the bearing bushing 111. The annular groove 1112 has a rectangular cross-section or a circular cross-section. In this embodiment, the annular groove 1112 has, but not limited to, a circular cross-section.

The bearing 12 is disposed in the bushing bore 1111 of the bearing bushing 111. The bearing 12 has an outer circumference 121. The bearing 12 is selected from the group consisting of a ball bearing, a roller bearing, a needle bearing, a ceramic bearing and an oil-retaining bearing. In this embodiment, the bearing 12 is, but not limited to, a ball bearing.

The resilient member 13 is fitted around the outer circumference 121 of the bearing 12 and correspondingly received in the annular groove 1112. The resilient member 13 is a silicone ring or a rubber ring.

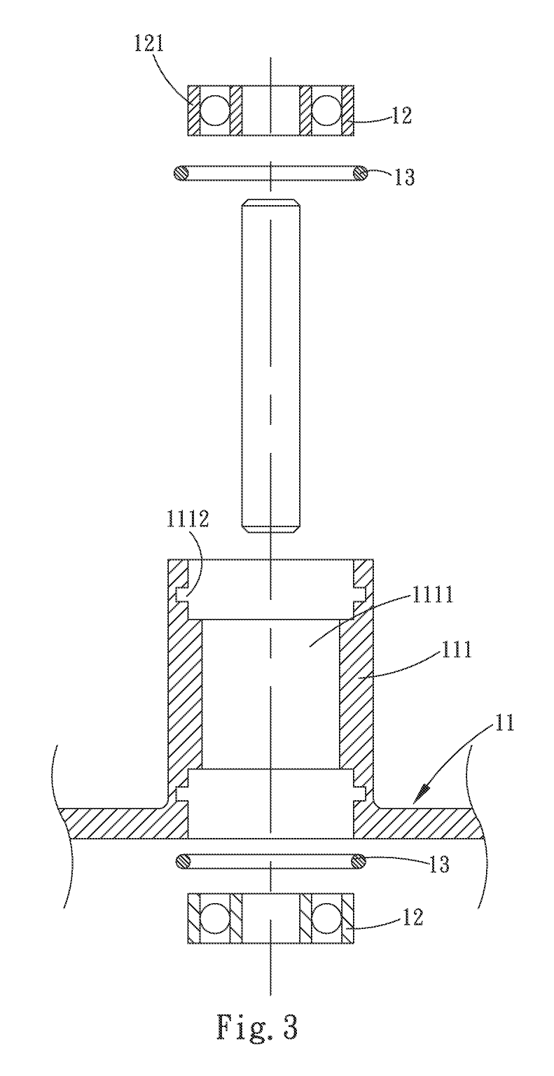

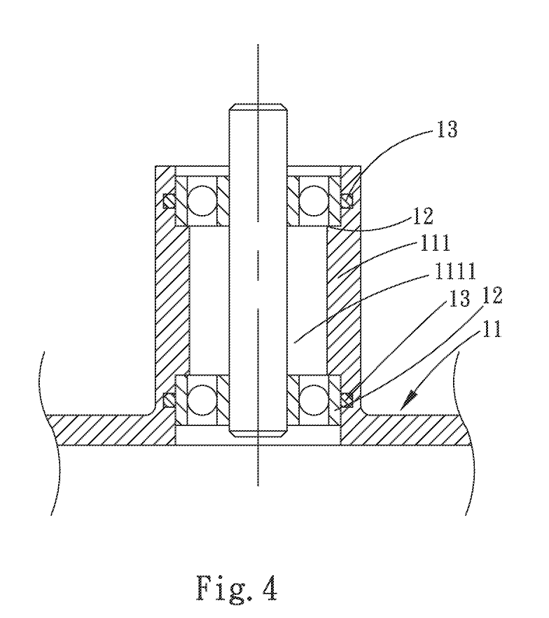

Please refer to FIGS. 3 and 4, which show a second embodiment of the present invention. The second embodiment is substantially identical to the first embodiment in technical characteristic and thus will not be repeatedly described hereinafter. The second embodiment is only different from the first embodiment in that the annular groove 1112 of the second embodiment has a rectangular cross-section.

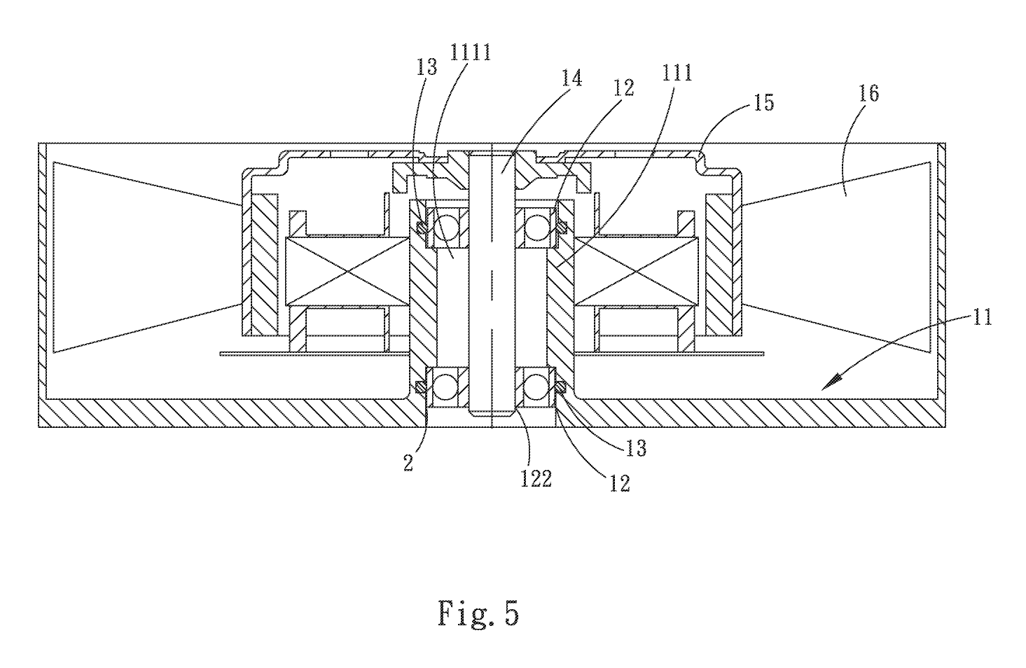

Please refer to FIG. 5, which shows a third embodiment of the present invention. The third embodiment is substantially identical to the first embodiment in technical characteristic and thus will not be repeatedly described hereinafter. The third embodiment is only different from the first embodiment in that the bearing 12 further has a shaft hole 122 in which a shaft 14 is rotatably disposed. One end of the shaft 14 is coupled with a hub 15. The hub 15 is provided with multiple blades 16 arranged around the hub 15.

Please further refer to FIGS. 1, 2, 3, 4 and 5. The bearing 12 is mounted in the bushing bore 1111 of the bearing bushing 111 in a loose-fit manner with a gap 2 existing therebetween. The resilient member 13 is received in the annular groove 1112 of the bearing bushing 111 to fill the gap 2. In this case, the bearing 12 can be securely assembled with the bearing bushing 111 without vibrating.

The above embodiments are only used to illustrate the present invention, not intended to limit the scope thereof. It is understood that many changes and modifications of the above embodiments can be made without departing from the spirit of the present invention. The scope of the present invention is limited only by the appended claims.

What is claimed is:

1. A fan bearing retaining structure comprising:
a fan base having a bearing bushing perpendicularly extending from one face of the fan base, the bearing bushing being formed with a bushing bore, an annular groove being formed on an inner circumference of the bearing bushing;
a bearing having an outer circumference, the bearing being disposed in the bushing bore of the bearing bushing; and
a resilient member fitted around the outer circumference of the bearing and correspondingly received in the annular groove.

2. The fan bearing retaining structure as claimed in claim 1, wherein the bearing further has a shaft hole in which a shaft is rotatably disposed, one end of the shaft being coupled with a hub, the hub being provided with multiple blades arranged around the hub.

3. The fan bearing retaining structure as claimed in claim 1, wherein the resilient member is a silicone ring or a rubber ring.

4. The fan bearing retaining structure as claimed in claim 1, wherein the annular groove has a rectangular cross-section or a circular cross-section.

5. The fan bearing retaining structure as claimed in claim 1, wherein the bearing is selected from the group consisting of a ball bearing, a roller bearing, a needle bearing, a ceramic bearing and an oil-retaining bearing.
